(19) United States
(12) Patent Application Publication
(10) Pub. No.: US 2026/0115916 A1
(43) Pub. Date: Apr. 30, 2026

(54) SIMULATION SYSTEM AND SIMULATION METHOD

(71) Applicant: KABUSHIKI KAISHA YASKAWA DENKI, Fukuoka (JP)

(72) Inventors: Arata TAKAKI, Fukuoka (JP); Hiroya KUWAHARA, Fukuoka (JP); Yuki OE, Fukuoka (JP)

(21) Appl. No.: 19/433,022

(22) Filed: Dec. 25, 2025

Related U.S. Application Data
(63) Continuation of application No. PCT/JP2024/024413, filed on Jul. 5, 2024.
(60) Provisional application No. 63/511,895, filed on Jul. 5, 2023.

(51) Int. Cl. B25J 9/16; B25J 19/02

(52) U.S. Cl. CPC B25J 9/1671; B25J 9/1612; B25J 9/1653; B25J 19/023

(57) ABSTRACT

Provided is a simulation system that simulates an operation of a cell including a robot and a device, wherein the simulation system comprises a virtual device that simulates an output of the device and a a virtual robot controller that simulates, according to an output of the virtual device, an operation of a robot controller that controls the robot, and the virtual device performs an output based on a plurality of output histories of the device.

The contents of the following patent application(s) are incorporated herein by reference:
NO. 63/511895 filed in US on Jul. 5, 2023
NO. PCT/JP2024/024413 filed in WO on Jul. 5, 2024.

### BACKGROUND

### 1. Technical Field

The present invention relates to a simulation system and a simulation method.

### 2. Related Art

Patent document 1 describes a simulation device comprising a first simulator which simulates control of a first machine by a first controller, a second simulator which simulates control of the second machine by the second controller; and a simulation manager that controls progress of simulation by the first simulator and progress of simulation by the second simulator so as to correspond to relation between progress of control by the first controller and progress of control by the second controller. Patent document 2 describes a simulation device that performs simulation of a robot by a robot program, wherein a separate file which is different from the robot program is further used, the separate file includes a command for setting a status of a signal or a command for setting a value of a data register, the command being described corresponding to a line of the robot program, the status and the value being referenced by executing the line of the robot program, and the setting of the status of the signal or the value of the data register described corresponding to the execution line is changed based on the command in synchronization with the execution line of the robot program, when the simulation is performed. Patent document 3 describes a control device for controlling a control target, the control device comprising a PLC engine configured to cyclically execute a program including a sequence instruction, a robot control engine configured to control a robot, an image processing engine configured to execute image processing on an image from a camera, and a simulation module configured to simulate at least a part of the control target, the robot, and the camera, the simulation module being constructed according to user setting.

### RELATED ART DOCUMENTS

### Patent Documents

Patent Document 1: U.S. Pat. No. 7,400,104
Patent Document 2: Japanese Patent Application Publication No. 2014-144524
Patent Document 3: Japanese Patent Application Publication No. 2022-043871

### BRIEF DESCRIPTION OF THE DRAWINGS

FIG. 1 schematically illustrates an example of a simulation system 10.

FIG. 2 schematically illustrates an example of a functional configuration of a simulator 100.

FIG. 3 schematically illustrates an example of a virtual environment 101.

FIG. 4 schematically illustrates an example of a processing flow at the simulation system 10.

FIG. 5 schematically illustrates an example of a processing flow at the simulation system 10.

FIG. 6 schematically illustrates an example of a processing flow at the simulation system 10.

FIG. 7 schematically illustrates an example of a hardware configuration of a computer 1200 that functions as the simulation system 10 or the simulator 100.

### DESCRIPTION OF EXEMPLARY EMBODIMENTS

The present invention will be described below through embodiments of the invention, but the following embodiments do not limit the invention according to the claims. In addition, not all combination of the features described in the embodiments are necessary for the solution of the invention.

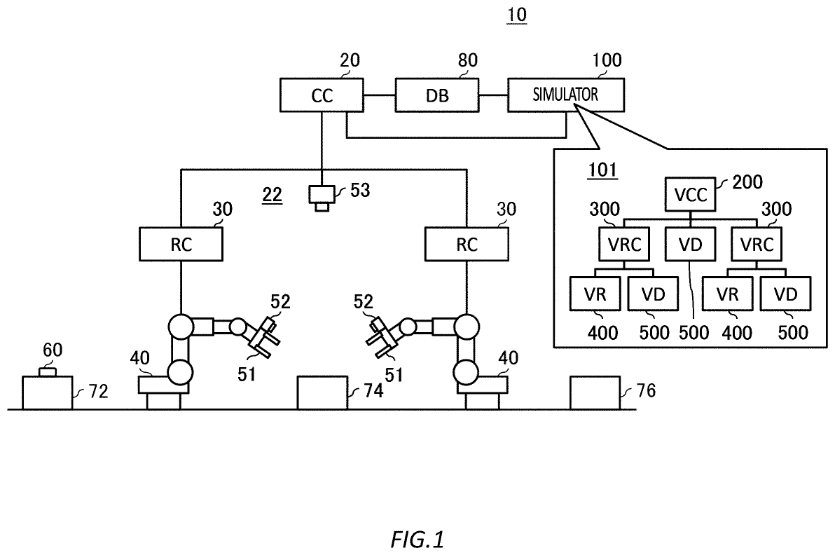

FIG. 1 schematically illustrates an example of a simulation system 10. The simulation system 10 simulates an operation of a cell 22 including a robot and a device in a real environment.

In FIG. 1, a real environment is illustrated in which a cell controller (CC) 20, a robot controller (RC) 30, a robot 40, which is a vertical articulated robot, a robot hand 51 and a vision sensor 52 arranged at a tip portion of the robot 40, a camera 53, a work 60, a rack 72, a rack 74, a rack 76, and a DB 80 are arranged. The real environment to which the simulation system 10 is directed is not limited thereto, and the simulation system 10 is capable of simulating an operation of the cell 22 including any kinds of industrial robots and any kinds of devices.

The CC 20 executes control of the cell 22 according to a program. The CC 20 may control cooperation between tasks of equipment such as the robot and the device, execution timing, transition of tasks and the like. The CC 20 may execute cooperation with a host controller. The

CC 20 may execute cooperation with a human machine interface (HMI). The CC 20 may execute cooperation with an engineering tool that is capable of generating a program for a controller, a robot, a device and the like. The CC 20 may be a programmable logic controller, for example. The RC 30 may be connected to the CC 20. In the example illustrated in FIG. 1, two RCs 30 are connected to the CC 20. The device may be connected to the CC 20. In the example illustrated in FIG. 1, the camera 53 is connected to the CC 20.

The RC 30 executes control of the robot 40 according to the program. The RC 30 repeatedly executes, at a predetermined control cycle, a segment processing in which the robot 40, the robot hand 51, and the vision sensor 52 are operated according to a control command, for example. In the present embodiment, the segment processing may be processing assigned per one cycle. The control command includes a command to execute a job program, for example. The job program is an operational program including one or more operation instruction in time series. The job program may be prepared in advance and stored in the RC 30.

In the real environment illustrated in FIG. 1, for example, the operation instruction of the robot 40 may include a target location and attitude of a tip of the robot 40, and a target movement speed of the tip portion to reach the target location and the attitude, and the segment processing may include calculating the target location and the attitude of the tip portion for each control cycle, calculating an operation target value for each of a plurality of actuators to move the tip portion to the calculated target location and attitude, and operating each of the plurality of actuators according to the calculated operation target value. The operation instruction of the robot hand 51 includes, for example, a closing instruction including closing a hand, and the time until the hand is closed or the speed at which the hand is closed. The operation instruction of the robot hand 51 may include closing confirmation instruction for confirming that the hand is closed. The operation instruction of the robot hand 51 includes, for example, an opening instruction including opening the hand, and the time until the hand is opened or the speed at which the hand is opened. The operation instruction of the robot hand 51 may include opening confirmation instruction for confirm that the hand is opened. The operation instruction of the vision sensor 52 includes a recognition instruction for performing image-capturing and recognition of a work, for example.

In the real environment illustrated in FIG. 1, for example, the CC 20 repeatedly executes, at a predetermined control cycle, the segment processing for coordinating operations of a plurality of robots 40. Said segment processing includes, for example, receiving status information of the plurality of robots 40 and the works 60 from the plurality of RCs 30 or the like, identifying, based on the program and the status information, the robot 40 to be caused to start an operation, and transmitting, to the robot 40 to be controlled, a control command to starting the operation.

Herein, an operation example of the cell 22 is described with an case in which the work 60 arranged on the rack 72 is grasped by the first robot 40 to be moved to the rack 74, and the work 60 arranged on the rack 74 is grasped by the second robot 40 to be moved to the rack 76. Note that, herein, although a simple operation is illustrated for the purpose of description, the operation of the cell 22 may be more complex.

For example, the CC 20 transmits, to the camera 53 that performs image-capturing of the entire cell 22, a recognition instruction to recognize a situation of the cell 22. The camera 53 may perform image-capturing of the entire cell 22 according to the recognition instruction and transmit the recognition result to the CC 20. The CC 20 may create or update the status information of the cell 22 by using the recognition result by the camera 53 and measurement result by another sensor in the cell 22, for example.

When it is determined that the work 60 has been arranged on the rack 72, based on the status information, the CC 20 transmits a control command including a job program execution command of an operation of the work 60 to a first RC 30. The first RC 30 controls a first robot 40, a first robot hand 51, and a first vision sensor 52 in order to move the work 60 from the rack 72 to the rack 74 according to the control command. For example, the first RC 30 transmits, to the first robot 40, an operation instruction including a target location, a target attitude, and a target speed of the tip portion relative to the rack 72. In response to receiving a completion response from the first robot 40, the first RC 30 transmits, to the first vision sensor 52, an operation instruction including performing image-capturing and recognition of the work 60, and transmits, to the first robot hand 51, an operation instruction including closing the hand and the time until the hand is closed and a closing confirmation instruction. The first robot hand 51 may start the operation of closing the hand according to said operation instruction, and in response to the hand being closed, may transmit a completion report to the first RC 30. The hand being closed may be performed by a sensor that detects a closed end, which is incorporated in the hand, for example. In response to receiving a completion response from the first vision sensor 52 and the first robot hand 51, the first RC 30 transmits, to the first robot 40, an operation instruction including a target location, a target attitude, and a target speed of the tip portion relative to the rack 74. In response to receiving the completion response from the first robot 40, the first RC 30 transmits, to the first robot hand 51, an operation instruction including the hand being opened and the time for the hand to be opened and an opening confirmation instruction. In response to receiving the completion response from the first robot hand 51, the first RC 30 transmits, to the first robot 40, an operation instruction including a target location, a target attitude, and a target speed of the tip portion relative to a default position.

When it is determined that the work 60 has been arranged on the rack 74, based on the status information, the CC 20 transmits a control instruction including a job program execution command of an operation of the work 60 to a second RC 30. The second RC 30 controls a second robot 40, a second robot hand 51, and a second vision sensor 52 in order to move the work 60 from the rack 74 to the rack 76 according to the control instruction. For example, the second RC 30 transmits, to the second robot 40, an operation instruction including a target location, a target attitude, and a target speed of the tip portion relative to the rack 74. In response to receiving a completion response from the second robot 40, the second RC 30 transmits, to the second vision sensor 52, an operation instruction including performing image-capturing and recognition of the work 60, and transmits, to the second robot hand 51, an operation instruction including closing the hand and the time until the hand is closed and a closing confirmation instruction. In response to receiving a completion response from the second vision sensor 52 and the second robot hand 51, the second RC 30 transmits, to the second robot 40, an operation instruction including a target location, a target attitude, and a target speed of the tip portion relative to the rack 76. In response to receiving the completion response from the second robot 40, the second RC 30 transmits, to the second robot hand 51, an operation instruction including the hand being opened and the time for the hand to be opened and an opening confirmation instruction. In response to receiving the completion response from the second robot hand 51, the second RC 30 transmits, to the second robot 40, an operation instruction including a target location, a target attitude, and a target speed of the tip portion relative to a default position.

The embodiment is not limited to operation of the robot 40 according to the control

command from the CC 20, and the CC 20 may achieve an autonomous distributed robot cell. That is, an embodiment is included in which the CC 20 carries out a role as an information bulletin board, and a plurality of RCs 30 autonomously operate based on information in the information bulletin board. For example, the CC 20 discloses, as status information, an execution result of operation of each of the plurality of RCs 30, and the plurality of RCs 30 makes a determination based on the disclosed status information to perform an operation.

The database (DB) 80 accumulates various types of data in the real environment. The

DB 80 may accumulate operation history of each equipment in the real environment. The DB 80 may accumulate measurement data by each equipment in the real environment. The DB 80 may accumulate feedback data by each equipment in the real environment. The DB 80 may accumulate measurement data obtained by performing measurement by various types of sensors (not shown) arranged in the real environment. As a specific example, the DB 80 may accumulate measurement data obtained by performing measurement by a sensor for measuring a movement of the robot 40 or a sensor for measuring a movement of the robot hand 51. The DB 80 may accumulate a communication delay history of each equipment in the real environment.

The DB 80 may accumulate instruction history data including histories of commands, instructions, responses and the like exchanged in the cell 22. The instruction history data may include a timestamp for each of the commands, instructions and responses.

The DB 80 may accumulate an output history of the equipment. The output history includes, for example, a response time taken by the equipment to respond to the commanding or the instruction. The response time may be the time it takes for the equipment to output a response after the command or instruction is input to the equipment. For example, the response time of the device is the time it takes for the device to output a response after the instruction from the RC 30 is input to the device. As a specific example, an operation result of the robot hand 51 includes the response time it takes for the robot hand 51 to open and close the hand and transmit a response after the opening and closing instruction is input to the robot hand 51. Note that, the opening and closing operation of the robot hand 51 is not limited to an operation of opening and closing the hand, and may be an operation of only opening the hand or may be an operation of only closing the hand. The output history includes output data output by the equipment, for example. For example, the output data of the device is data output to the RC 30 by the device. As a specific example, the output history of the vision sensor 52 includes a recognition result of the work 60. The recognition result of the work 60 may include at least any of a position, an attitude, and a kind of the recognized work 60.

The DB 80 may accumulate the output history of the equipment and environment information indicating the environment of the equipment when the equipment performed the output in association with each other. The environment information may indicate spatial environment in which the equipment is installed. The environment information is measured by a sensor arranged in a space of the cell 22, for example. The spatial environment may include a temperature of the space. The spatial environment may include a humidity of the space. The environment information may include an operation period of the equipment. The operation period of the equipment may be an elapsed period since the equipment was newly installed and started operation.

The simulation system 10 may include a virtual environment 101 constructed by the simulator 100, in which the real environment is virtualized. The virtual environment 101 includes a virtual device (VD) 500 that simulates an output of the device. The virtual environment 101 includes a virtual robot controller (VRC) 300 that simulates an operation of the RC 30. The virtual environment 101 includes a virtual robot (VR) 400 that simulates the robot 40. The virtual environment 101 may include a virtual cell controller (VCC) 200 that simulates the CC 20. The simulator 100 may be an example of the simulation system constructing apparatus.

The VRC 300 may simulate an operation of the RC 30 according to an output of the VD

500. Simulating the operation of the RC 30 according to the output of the VD 500 may include simulating the operation of the RC 30 by directly using the output of the VD 500, or may include simulating the operation of the RC 30 by indirectly using the output of the VD 500. For example, the VRC 300 acquires a result obtained by processing the output from the VD 500 at the VCC 200 and simulates the operation of the RC 30 by using the acquired result. As a specific example, the VRC 300 acquires a result of using, by the VCC 200, the output from the VD 500 for the control, and performs control of the like of the VR 400 by using the acquired result. The VCC 200 may simulate the operation of the CC 20 according to an output of the VRC 300. The VCC 200 may simulate the operation of the CC 20 according to an output of the VD 500.

The simulation system 10 may include the simulator 100. That is, the simulation system 10 may include a simulator 100 and a virtual environment 101 constructed by the simulator 100.

The VCC 200 may execute a program for controlling segment processing, based on production indication information from the host controller, similarly to the CC 20. The program used by the VCC 200 may be created or set by an engineering tool.

The VRC 300 may control the VR 400 in the same manner as the control of the robot 40 by the RC 30. The program used by the VRC 300 may be created or set by a pendant software. The VRC 300 may be capable of creating a program that can be used as is by the robot 40.

[Output based on a plurality of output histories of a real device]

An input/output with the device is required in order to confirm the operation of programs of the VCC 200 and the VRC 300. For example, by creating a virtual device that outputs a preset theoretical value for an input of the VRC 300, the operation of the cell 22 can be simulated, and the operation of the programs of the VCC 200 and the VRC 300 can be confirmed. However, the output of the real device may vary due to various factors even when performing the same operation. Nevertheless, when a virtual device that outputs a theoretical value is used, the real environment cannot be accurately simulated, and when the simulation result is reflected to the real device, a situation may occur where a result that is different from what is expected, such as the occurrence of an unexpected error. To the contrary, the VD 500 according to the present embodiment performs an output based on a plurality of output histories of the real device, which is the simulation target. The VD 500 may perform the output such that the output is varied in the same way as the real device, based on the plurality of output histories of the real device. The VD 500 may perform the output by using the plurality of output histories of the real device, which are accumulated in the DB 80.

Performing the output by the VD 500 based on the plurality of output histories of the real device can bring the output of the VD 500 closer to the output of the real device and can contribute to improvement in the accuracy of the simulation. By improving the accuracy of the simulation, when a program having been adjusted or created based on the simulation result is reflected to a real device, the possibility of achieving an operation as expected can be improved. For example, when an adjustment is made to increase a throughput of the cell 22 based on the simulation result, the throughput may be increased as expected, as well as an unexpected error may be made not to occur through the adjustment. For example, in order to achieve variable product types and quantities, even when the operation of the cell 22 is changed or the layout of the cell 22 is changed based on the simulation result, a target object can be appropriately processed, and also an unexpected error can be made not to occur.

The VD 500 may perform output that is different for each output based on the plurality of output histories of the real device. The output of the real device is often not the same for each output. Performing, by VD 500, the output that is different for each output while using the plurality of outputs of the real device can bring the output of the VD 500 closer to the output of the real device, and can contribute to improving the accuracy of the simulation.

### [Variation in Response Time]

The VD 500 performs an output such that the response time differs for each output, based on the plurality of output histories of the real device, for example. For example, the VD 500 computes a plurality of past response times from the plurality of output histories, and based on the plurality of past response times computed, performs the output such that the response time differs for each output. The output history may include past response times, and the VD 500 may perform the output such that the response time differs for each output, based on the plurality of past response times included in the plurality of output histories. Even when the real device repeatedly executes the same operation, its response time may differ. For example, after being input with an instruction, the real device performs an operation according to the instruction to output a response upon completion of the operation, but the response time may differ due to variation in the time it takes for the operation. To the contrary, by performing the output by the VD 500 such that the response time differs for each output, based on the plurality of output histories of the real device, instead of responding within a response time of a preset fixed value, the variation in the response time of the real device can be replicated, which can contribute to the improvement of the accuracy of the simulation.

For example, the VD 500 that simulates the output of the robot hand 51 performs an output such that the response time differs for each output based on a plurality of opening and closing operation histories of the robot hand 51. In a case where the robot hand 51 repeatedly executes a predetermined task, for example, when the work 60 is repeatedly grasped, the response time may differ since the time it takes for the hand to be closed may differ depending on the position, the attitude, the kind and the like of the work 60 to be grasped. To the contrary, by performing, by the VD 500, the output such that the response time differs for each output based on the past opening and closing operation histories of the real robot hand 51, instead of responding within a response time of a preset fixed value, the variation in the response time of the real robot hand 51 can be replicated, which can contribute to the improvement in the accuracy of the simulation. Note that, the same is applied to other devices such as the vision sensor 52, the camera 53, and an automatic guided vehicle (AGV), where the VD 500 may perform an output such that the response time differs for each output, based on a plurality of operation histories of the real device to be simulated.

### [Variation in Output Data]

The VD 500 outputs output data that is different for each output based on a plurality of output histories of the real device, for example. For example, the VD 500 outputs output data that is different for each output based on the plurality of pieces of past output data of the real device. The real device performs a predetermined operation to create output data, and outputs the output data to the RC 30, for example. Even when the same operation is repeatedly performed, the output data output by the real device may differ due to various factors. To the contrary, by outputting, by the VD 500, the output data that is different for each output based on the plurality of pieces of past output data of the real device, instead of outputting fixed output data that is preset, the variation in the output data of the real device can be replicated, which can contribute to the improvement in the accuracy of the simulation.

For example, the VD 500 that simulates the output of the vision sensor 52 outputs a different recognition result for each output based on a plurality of recognition results of the vision sensor 52. In such a case where the robot 40 repeatedly performs transportation of the work 60, the vision sensor 52 will repeatedly recognize the work 60. Even in such a repeating operation, the arrangement (position, attitude), the kind or the like of the work 60 that is recognized by the vision sensor 52 in the real environment may differ each time. To the contrary, instead of outputting a fixed recognition result that is preset, by outputting a different recognition result for each output based on a plurality of past recognition results of the real vision sensor 52 by the VD 500, the variation in the recognition results of the real vision sensor 52 can be replicated, which can contribute to the improvement in the accuracy of the simulation. Note that, the arrangement or the like of the work 60 in the virtual environment 101 may be changed according to the output by the VD 500. That is, when the recognition result of the work 60 is varied by the VD 500, the arrangement or the like of the work 60 in the virtual environment 101 is changed according to that variation. In this manner, the recognition results of the VD 500 may be reflected to variables for operating the VCC 200 and the VRC 300 and also to the arrangement or the like of the work 60, which is the subject. In this manner, the output by the VD 500 for the VCC 200 and the VRC 300 can be varied similarly as the output of the real vision sensor 52, and that variation can also be reflected in a scene where the work 60 is subsequently handled, to enable normal execution of the simulation.

### [Variation Due to Selective Use of Output History]

For example, the VD 500 selects one output history for each output from a plurality of output histories of the real device, and outputs the same. For example, the VD 500 selects one response time for each output from a plurality of response times, and performs the output in the selected response time. For example, the VD 500 selects one piece of output data for each output from a plurality of pieces of output data, and outputs the selected output data. Although it is possible to model the variation in the output from the plurality of output histories and use the same, there is a possibility that an error from the actual data may occur during the modeling process. If an error occurred, the output of the VD 500 may differ from the output of the real device, which may lower the accuracy of the simulation.

To the contrary, by using the plurality of output histories of the real device as it is by the VD 500, an output proven by the real device can be performed, which can contribute to the improvement in the accuracy of the simulation.

### [Using the Output History in a Time Series Order]

The VD 500 selects and outputs, in a time series order, output histories from the plurality of time series output histories of the real device, for example. For example, the VD 500 selects, from a list in which the response time histories of the real device are registered in a time series order, a response time for each output in a time series order and performs output at the selected response time. For example, the VD 500 selects, from a list in which the output data histories of the real device is registered in a time series order, output data for each output in a time series order, and outputs the selected output data.

Although it is possible to model the variation in the outputs from the plurality of output histories and use the same, by using the model, the tendency of occurrence of the variation will be closer to the real device, but the varied value may differ each time. To the contrary, by selecting an output history from the plurality of output histories in a time series order and using the same, the output of the VD 500 will become equivalent to that of the real device, where the program of the VCC 200 and the VRC 300 or the like can be changed, which enables verification of engineering of the cell 22 to be performed without changing conditions for the VD 500. In addition, since the same variation can be achieved by the VD 500 each time, a difference that occurred before and after the change in the program of the VCC 200 and the VRC 300 or the like can be handled as being caused by the program of the VCC 200 and the VRC 300 or the like, which can facilitate confirmation of the effect of the change in the program.

In addition, there is a possibility that the variation in the outputs of the real device is dependent on the time series. For example, when the response time is delayed relative to a reference time, there are cases where the state in which delay is continued or cases where the delay is reduced in the next output. As a specific example, if a feedback control related to the response time is performed, the delay tends to be decreased in the next output. To the contrary, when a model is used or a random selection is performed from a plurality of output histories, the dependency on time series cannot be replicated, but by selecting output histories in a time series order by the VD 500, the dependency of the variation on the time series can be replicated.

[Output of the VD 500 based on the operation history of the RC 30] The VRC 300 may perform a simulation based on the operation history of the RC 30, and the VD 500 may select, from the plurality of output histories of the real device, one output history corresponding to the timing of the operation history on which the VRC 300 is based, and output the same. The following Table 1 simply illustrates an example of a time series relationship between the operation histories of the RC 30 and output histories of the device to be simulated by the VD 500. The VRC 300 executes a simulation for an operation using an operation history Ra, executes a simulation for an operation using an operation history Rb, and executes a simulation for an operation using an operation history Rc. When performing an output for the operation using the operation history Ra by the VRC 300, the VD 500 selects an output history Da corresponding to the timing of the operation history Ra, and performs the output using the output history Da. When performing an output for the operation using the operation history Rb by the VRC 300, the VD 500 selects an output history Db corresponding to the timing of the operation history Rb, and performs the output using the output history Db. When performing an output for the operation using the operation history Rc by the VRC 300, the VD 500 selects an output history Dc corresponding to the timing of the operation history Rc, and performs the output using the output history Dc. Since it can be considered that the variation in the operations of the RC 30 and the variation in the outputs of the device are correlated, in a case where the VD 500 performs the output for the operation using the operation history Ra by the VRC 300, there may be cases where the variation in the real environment cannot be replicated when the output is performed using an output history other than the output history Da. To the contrary, by selecting, from a plurality of output histories of the real device, one output history corresponding to the timing of the operation history based on the VRC 300 and outputting the same by the VD 500, the same variation as the real environment can be replicated, which can contribute to the improvement in the accuracy of the simulation.

TABLE 1

| TIME SERIES | RC 30 | DEVICE |
|---|---|---|
| 1001 | OPERATION HISTORY Ra | |
| 1002 | | OUTPUT HISTORY Da |
| 1003 | | |
| 1004 | | |
| 1005 | OPERATION HISTORY Rb | |
| 1006 | | OUTPUT HISTORY Db |
| 1007 | | |
| 1008 | | |
| 1009 | OPERATION HISTORY Rc | |
| 1010 | | OUTPUT HISTORY Dc |

.
.
.

### [Output of a Plurality of VDs 500]

Two or more VDs 500 may respectively select, from a plurality of output histories of a real device to which each of the VDs 500 corresponds, one output history at a timing corresponding with each other, and output the same.

For example, a first VD 500 and a second VD 500 that respectively simulate the robot hand 51 and the vision sensor 52 arranged at the tip portion of one robot 40 of the two robots 40 illustrated in FIG. 1 respectively select, from a plurality of output histories of the robot hand 51 and the vision sensor 52, one output history at a timing that corresponds with each other, and outputs the same. The following Table 2 simply illustrates an example of a time series relationship between the output histories of the vision sensor 52 and the output histories of the robot hand 51. In a case where the output histories of the vision sensor 52 and the robot hand 51 are as the example illustrated in the following Table 2, the first VD 500 and the second VD 500 firstly select and output an output history Aa and an output history Ba at a timing corresponding with each other, then select and output an output history Ab and an output history Bb, which are the next in the time series order and are at a timing corresponding with each other, and then select and output an output history Ac and an output history Bc, which are the next in the time series order and are at a timing correspond with each other.

TABLE 2

| TIME SERIES | VISION SENSOR 52 | ROBOT HAND 51 |
|---|---|---|
| 1001 | OUTPUT HISTORY Aa | |
| 1002 | | OUTPUT HISTORY Ba |
| 1003 | | |
| 1004 | | |
| 1005 | OUTPUT HISTORY Ab | |
| 1006 | | OUTPUT HISTORY Bb |
| 1007 | | |
| 1008 | | |
| 1009 | OUTPUT HISTORY Ac | |
| 1010 | | OUTPUT HISTORY Bc |

.
.
.

In addition, for example, the first VD 500 and the second VD 500 that respectively simulate the first robot hand 51 and the first vision sensor 52 arranged at the tip portion of the first robot 40 of the two robots 40 illustrated in FIG. 1 and a third VD 500 and a fourth VD 500 that respectively simulate the second robot hand 51 and the second vision sensor 52 arranged at the tip portion of the second robot 40 respectively selects, from a plurality of output histories of the first robot hand 51, the first vision sensor 52, the second robot hand 51, and the second vision sensor 52, one output history at a timing correspond with each other, and output the same.

When two or more VDs 500 corresponding to two or more devices that are related to one another adopt output histories at different timings, a variation that is different from the real environment will be replicated, which lowers the accuracy of the simulation. For example, in a case where a second device is operated after a first device is operated, and further the second device is operated after the first device is operated, when output histories that are irrelevant to this order are used, the variation becomes different from that in the real environment; on the other hand, by selecting and using output histories in this order, the same variation as that in the real environment can be replicated, which can contribute to the improvement in the accuracy of the simulation.

### [Variation in the Output Due to Probability Distribution or the Like]

The VD 500 may perform an output by using a probability distribution created based on a plurality of output histories. By using said probability distribution, a value included in the plurality of output histories and a value that is not included in the plurality of output histories will be output, according to an appearance probability of each value in the plurality of output histories. By executing a simulation in which the VD 500 performs an output using said probability distribution, events that only occur with a probability of 0.1% or 0.01% in said probability distribution can be made possible to be confirmed in the simulation. In this manner, for example, an event that is difficult to be caused to occur in a real device during an equipment establishing period can easily be caused to occur in the simulation. Note that, the VD 500 may perform the output by using a learning model that performs an output in accordance with the tendency of a plurality of output histories created through machine learning using the plurality of output histories.

### [Variation in Outputs Using a Minimum Value and a Maximum Value]

The VD 500 may perform a different output for each output by randomly creating a value for each output within a range from a minimum value to a maximum value in plurality of output histories. As a specific example, the VD 500 identifies the minimum value and the maximum value of the plurality of response times, and randomly creates a response time for each output within the range from the minimum value to the maximum value.

### [Manual Setting of Variation]

The VD 500 may perform the output according to an output that is manually set. For example, the simulator 100 provides, to a user, a setting screen on which an output can be set for each output, and accepts the setting of an output for each output. The VD 500 performs an output for each output that is set by the user.

### [Use of Output History of a Real Device in the Same Environment as the Simulation]

The VD 500 may perform an output by using a plurality of output histories, among the plurality of output histories of the real device, for which the associated environment information corresponds to the simulation environment.

For example, the VD 500 performs an output by using a plurality of output histories, among the plurality of output histories, for which the associated environment information matches or approximates a spatial environment to be simulated. As a specific example, when a simulation is to be executed by specifying the temperature and humidity in the cell 22, the VD 500 performs an output by using a plurality of output histories, among the plurality of output histories of the real device, for which the associated environment information matches or approximates the specified temperature and humidity. In this manner, the variation in the output when the real device is operated in the same environment as the spatial environment to be simulated can be easily replicated, which can contribute to the improvement in the accuracy of the simulation.

In addition, for example, the VD 500 performs an output by using a plurality of output histories, among the plurality of output histories, for which the associated environment information corresponds to an operation period of the equipment attempted to be simulated. As a specific example, when a new device is to be simulated, the VD 500 performs an output by using a plurality of output histories, among the plurality of output histories, for which the associated environment information indicates that the device is new. Being new may be, for example, that the operation period is within one year. In addition, as a specific example, when a device having been in use for five years is to be simulated, the VD 500 performs an output by using a plurality of output histories, among the plurality of output histories, for which the associated environment information indicates that it has been in use for five years. In this manner, the variation in the output of the device when it is new can be replicated when performing a simulation directed to a new device, and the variation in the output of the device when it has been in use for five years can be replicated when performing a simulation for a device that has been in use for five years, which can contribute to the improvement in the accuracy of the simulation.

### [Another Example of the Simulation System 10]

The simulation system 10 may include the VD 500 that simulates the output of the real device and the RC 30 that controls the robot 40 according to the output of the VD 500. In this case, the simulator 100 may create only the VD 500. By creating a VD 500 that performs an output based on a plurality of output histories of the real device according to an instruction from the real RC 30, an input/output between the RC 30 and the device can be simulated in a closer way as the real environment. In addition, in order to simulate an input/output between the RC 30 and various devices, the simulation can be made possible without actually preparing a device.

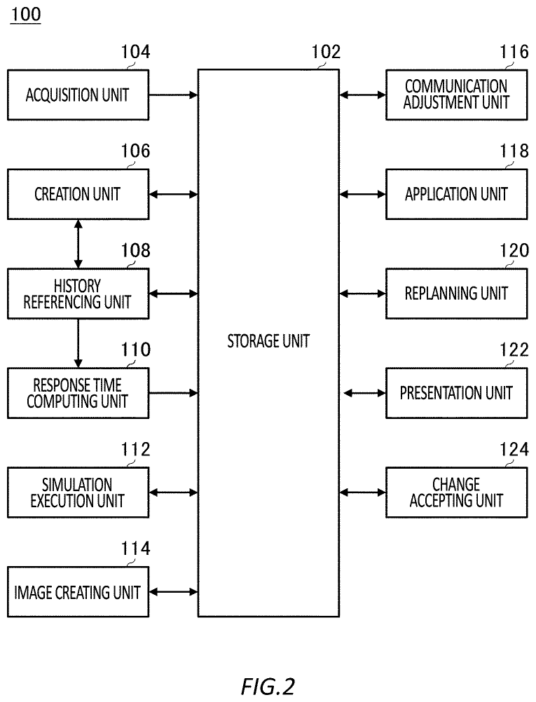

FIG. 2 schematically illustrates an example of a functional configuration of the simulator 100. The simulator 100 includes a storage unit 102, an acquisition unit 104, a creation unit 106, a history referencing unit 108, a response time computing unit 110, a simulation execution unit 112, an image creating unit 114, a communication adjustment unit 116, an application unit 118, a replanning unit 120, a presentation unit 122, and a change accepting unit 124. Note that, the simulator 100 does not necessarily have to include all of the above.

The storage unit 102 stores various types of data. For example, a part or all of the data accumulated in the DB 80 is copied in the storage unit 102.

The acquisition unit 104 acquires various types of data. The acquisition unit 104 acquires data input by the user of the simulator 100, for example. The storage unit 102 stores the data acquired by the acquisition unit 104.

The acquisition unit 104 may acquire data for creating the virtual environment 101. For example, the acquisition unit 104 acquires layout data of the cell 22. The layout data of the cell 22 may include the arrangement of each equipment in the cell 22. The acquisition unit 104 may acquire data for simulating the CC 20. The data for simulating the CC 20 may include data indicating a function of the CC 20, a program of the CC 20 and the like. The acquisition unit 104 may acquire data for simulating the RC 30. The data for simulating the RC 30 may include data indicating a function of the RC 30, a program of the RC 30, and the like. The acquisition unit 104 may acquire data for simulating the robot 40. The data for simulating the robot 40 may include data indicating a function of the robot 40, a program of the robot 40, or the like. The acquisition unit 104 may acquire data for simulating the device. For example, the acquisition unit 104 acquires a trigger condition and an output target to be output when the trigger condition is satisfied.

The creation unit 106 creates the virtual environment 101 by using the data stored in the storage unit 102. For example, the creation unit 106 creates the VCC 200, the VRC 300, the VR 400, the VD 500 and the like, and creates the virtual environment 101 by performing the layout.

The creation unit 106 creates the VD 500 that outputs the output target to be output when the trigger condition is satisfied, based on the trigger condition and the output target acquired by the acquisition unit 104.

The history referencing unit 108 references the output history of the real device that is simulated by the VD 500 created by the creation unit 106. The creation unit 106 may configure the VD 500 to perform an output based on a plurality of output histories referenced by the history referencing unit 108.

For example, in a case where the response time is referenced, when the response times of the real device are accumulated in the DB 80, the history referencing unit 108 references the response times accumulated in the DB 80. When the response times of the real device are stored in the storage unit 102, the history referencing unit 108 may reference the response times accumulated in the storage unit 102.

When the response times of the real device are not accumulated in the DB 80, and instruction history data indicating an instruction to the device and a response from the device at each time are accumulated, the response time computing unit 110 may compute a plurality of response times from the plurality of pieces of instruction history data. For example, the response time computing unit 110 identifies a starting time at which the state of the instruction to the device satisfies a starting condition and an ending time at which the state of the response from the device satisfies an ending condition, and computes, as the response time, the time between the starting time and the ending time. The following Table 3 simply illustrates an example of a plurality of pieces of instruction history data of the robot hand 51. The time series column simply indicates the timestamp, and a larger value indicates the advance in time. The execution instruction column indicates on/off of the opening and closing instruction from the RC 30 to the robot hand 51. The completion response column indicates on/off of a completion response from the robot hand 51 to the RC 30. When the opening and closing instruction is an instruction to close the hand, the time at which the execution instruction column changes from 0 to 1 indicates the time at which the instruction is input from the RC 30 to the robot hand 51 and the hand begins to close, and the time at which the completion response column changes from 0 to 1 indicates the time at which the hand is finished closing and the response to the RC 30 is output by the robot hand 51. The response time computing unit 110 may compute, as the response time, the time between the time at which the execution instruction column changed from 0 to 1 and the time at which the completion response column changed from 0 to 1. In this manner, by computing the response time from the instruction history data by the response time computing unit 110, the VD 500 whose output is appropriately varied can be prepared, merely by preparing instruction history data of the real device, which can reduce the preparation load of prior data.

TABLE 3

| | COMPLETION | EXECUTION |
|---|---|---|
| TIME SERIES | RESPONSE | INSTRUCTION |
| 1001 | 0 | 0 |
| 1002 | 0 | 0 |
| 1003 | 0 | 1 |
| 1004 | 0 | 1 |
| 1005 | 0 | 1 |

.
.
.

| | | |
|---|---|---|
| 1021 | 0 | 1 |
| 1022 | 0 | 1 |
| 1023 | 1 | 1 |
| 1024 | 1 | 1 |
| 1025 | 1 | 1 |

.
.
.

For example, in a case where the output data is referenced, when the output data of the real device is accumulated in the DB 80, the history referencing unit 108 references the output data accumulated in the DB 80. When the output data of the real device is stored in the storage unit 102, the history referencing unit 108 may reference the output data accumulated in the storage unit 102.

The creation unit 106 may create a list of an output for each output of the VD 500 by using the plurality of output histories referenced by the history referencing unit 108. For example, in a case where the VD 500 performs the same operation three times and performs an output each time, when the response time is to be varied, the creation unit 106 creates a list including the response time for the first round, the response time for the second round, and the response time for the third round. The response time for each round may be the response time itself, and, for example, the response time for the first round is 2.9 seconds, the response time for the second round is 3.0 seconds, and the response time for the third round is 3.1 seconds. The response time for each round may be a difference from a default response time, and, for example, when the default response time is 3.0 seconds, the response time for the first round is-0.1 seconds, the response time for the second round is 0 seconds, and the response time for the third round is +0.1 seconds. The VD 500 may perform the response for the first round, the response for the second round, and the response for the third round by using said list.

The simulation execution unit 112 executes a simulation using the virtual environment 101 created by the creation unit 106. The simulation execution unit 112 simulates the operation of the cell 22 by operating the VCC 200, the VRC 300, the VR 400, and the VD 500 included in the virtual environment 101. By performing an output based on the plurality of output histories of the real device by the VD 500, the output of the VD 500 can be made closer to the real environment, which enables the simulation execution unit 112 to execute a simulation with high accuracy. A user of the simulator 100 may consider, while referencing the simulation result by the simulation execution unit 112, changing or the like of a program on which each equipment in the virtual environment 101 is based when being operated.

The simulation execution unit 112 may execute the simulation using the virtual environment 101 created by the creation unit 106, in a state where the real environment does not exist. In this case, the creation unit 106 may create the VD 500 that performs an output according to an output that is manually set. Executing the simulation using such virtual environment 101 by the simulation execution unit 112 can enable simulation of the operation of the entire cell 22 and verifying feasibility of the cell 22, such as interference or cycle time, before constructing the real environment. After the real environment has been set up, the data in the real environment is accumulated in the DB 80, and the virtual environment 101 in which the real environment is virtualized is constructed by the creation unit 106.

The image creating unit 114 creates various types of images in the virtual environment 101. For example, the image creating unit 114 creates an image, which is to be the recognition result of the work 60 by the VD 500 that simulates the vision sensor 52. The image creating unit 114 creates a different image for each output based on a plurality of recognition results of the work 60 by the vision sensor 52, for example. The recognition result of the work 60 by the vision sensor 52 may include the position, the attitude, and the kind of the work 60, or may include the image itself of the work 60. The VD 500 may output the recognition result of the work 60 in the image. By outputting, by the VD 500, the recognition result of the work 60 in the image created to be different for each output, a different recognition result will be output for each output.

The communication adjustment unit 116 adjusts communication between each equipment in the virtual environment 101. The communication adjustment unit 116 may adjust the communication between each equipment in the virtual environment 101, based on communication delay history between each equipment in the real environment that is accumulated in the DB 80. For example, the communication adjustment unit 116 adjusts the communication delay between the VRC 300 and the VD 500 based on a plurality of communication delay histories between the RC 30 and the device. The communication adjustment unit 116 may adjust the communication delay between the VRC 300 and the VD 500 such that the communication delay between the VRC 300 and the VD 500 is varied similarly to the real environment, based on the plurality of communication delay histories. For example, the communication adjustment unit 116 selects, from the plurality of communication delay histories, one communication delay history that is different for each communication, and reflects the selected communication delay history to the communication between the VRC 300 and the VD 500. The communication adjustment unit 116 may adjust the communication delay between the VRC 300 and the VD 500 to be varied similarly to the real environment by using probability distribution, by using a learning model, or by using a minimum value and a maximum value of the communication delay history. The communication adjustment unit 116 may adjust the communication delay between the VCC 200 and the VD 500 based on a plurality of communication delay histories between the CC 20 and the device, in a similar way as the adjustment of the communication delay between the VRC 300 and the VD 500 based on the plurality of communication delay histories between the RC 30 and the device. Causing the output of the VD 500 to be varied similarly to that in the real environment, as well as causing the communication delay between the VD 500 and the VRC 300 and the communication delay between the VD 500 and the VCC 200 to also be varied similarly to those in the real environment can enable performing the simulation in a closer way as in the real environment.

The application unit 118 applies, to the real environment, a change in the program of each equipment in the virtual environment 101, considered through the simulation by the simulation execution unit 112. For example, the application unit 118 applies, to the RC 30, the change in the program of the VRC 300. For example, the application unit 118, applies to the CC 20, the change in the program of the VCC 200.

The replanning unit 120 performs replanning of a program on which the equipment of in the real environment is based when being operated, based on the result of the simulation by the simulation execution unit 112. The program replanned by the replanning unit 120 may be applied by the application unit 118 to the equipment in the real environment.

For example, the replanning unit 120 performs replanning of the program on which the RC 30 is based when being operated, based on the output of the VD 500 that is varied based on a plurality of output histories of the real device and the simulation result by the VRC 300 according to said output. By performing the simulation using the VD 500 whose output varied based on the plurality of output histories of the real device, a simulation taking into consideration the variation in the output of the device that may actually occur can be achieved, and by replanning the program of the RC 30 by using that simulation result, when said program is applied to the RC 30, a program that is capable of achieving an expected improvement can be created without causing an unexpected error or the like to occur.

The replanning unit 120 changes at least any of selection of a command to instruct an operation of a robot, an order of commands, adjustment of command arguments, a logic to invoke a command, or timing at which a command is to be invoked, in the program, based on an output of the VD 500 and the simulation result by the VRC 300 based on the program according to said output, for example.

When an error occurs in a simulation performed while varying the output of the VD 500, for example, the replanning unit 120 modifies the program to avoid the error. As a specific example, when an error occurs such as the robot 40 colliding with some obstacle in the middle of its operation, a teaching point of the robot 40 is modified such that the collision does not occur. The replanning unit 120 may confirm that the error does not occur by executing a simulation by the VRC 300 multiple times based on the modified program and according to the output of the VD 500. When the output of the VD 500 is fixed, even if it is confirmed that the error does not occur, the possibility of the occurrence of an error cannot be denied due to variation in the output of the device in the real environment; however, by the use of the VD 500 according to the present embodiment, since the variation in the output that may actually occur can be replicated, the possibility of the occurrence of an unexpected error can be reduced after the modified program is applied to the real environment.

Similarly to the replanning of the program on which the RC 30 is based when being operated, based on the output of the VD 500 that is varied based on the plurality of output history of the real device and the simulation result by the VRC 300 according to said output, the replanning unit 120 may perform replanning of the program on which the CC 20 is based when being operated, based on the output of the VD 500 that is varied based on the plurality of output histories of the real device and the simulation result by the VCC 200 according to said output.

The presentation unit 122 presents, to the user, information related to the replanning of the program by the replanning unit 120. The presentation unit 122 may present the information to the user by displaying the information on a display, or by transmitting the information to a communication terminal owned by the user. The presentation unit 122 executes the simulation by the VRC 300 multiple times based on the modified program, for example, and according to the output of the VD 500 and presents, to the user, the program having been confirmed that no error occurs as a proposed change to the program of the RC 30. The presentation unit 122 executes the simulation by the VCC 200 multiple times based on the modified program and according to the output of the VD 500, for example, and presents, to the user, the program having been confirmed that no error occurs as a proposed change to the program of the CC 20. The change accepting unit 124 accepts a change indication of the program from the user who viewed the proposed change to the program. The change accepting unit 124 accepts a change indication to change the program of the RC 30 according to the proposed change to the program presented by the presentation unit 122, for example. In response to accepting said change indication, the change accepting unit 124 may cause the application unit 118 to apply the changed program to the RC 30. The change accepting unit 124 accepts a change indication to change the program of the CC 20 according to the proposed change to the program presented by the presentation unit 122, for example. In response to said change indication change being accepted by the change accepting unit, the accepting unit 124 may cause the application unit 118 to apply the changed program to the CC 20.

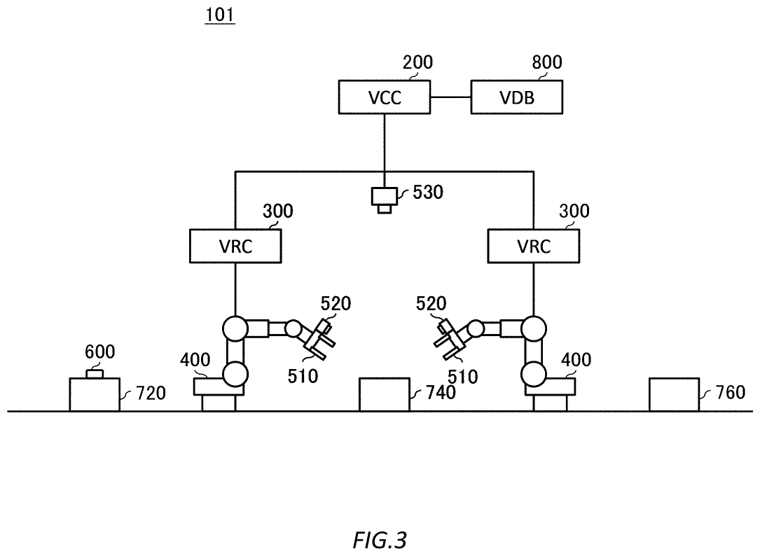

FIG. 3 schematically illustrates an example of the virtual environment 101. The virtual environment 101 illustrated in FIG. 3 includes the VCC 200, the VRC 300, the VR 400, a V robot hand 510 that simulates the robot hand 51, a V vision sensor 520 that simulates the vision sensor 52, a V camera 530 that simulates the camera 53, a V work 600, a V rack 720, a V rack 740, a V rack 760, and a virtual database (VDB) 800.

The VCC 200 executes control of the cell in the virtual environment 101 according to the program. The VRC 300 executes control of the VR 400 according to the program. The V robot hand 510 performs an output based on a plurality of output histories of the robot hand 51. The V robot hand 510 may perform an output such that a variation in the output of the robot hand 51 is replicated. The V vision sensor 520 performs an output based on a plurality of output histories of the vision sensor 52. The V vision sensor 520 may perform the output such that a variation in the output of the vision sensor 52 is replicated. The V camera 530 performs an output based on a plurality of output histories of the camera 53. The V camera 530 may perform the output such that a variation in the output of the camera 53 is replicated. The VDB 800 accumulates various types of data in the virtual environment 101.

The simulation execution unit 112 may execute a simulation using the virtual environment 101. The simulation execution unit 112 executes, for example, a simulation in which a first VR 400 grasps the V work 600 arranged on the V rack 720 to move it onto the V rack 740 and a second VR 400 grasps the V work 600 arranged on the V rack 740 to move it onto the V rack 760. In said simulation, each VD 500 performs an output such that a variation of a target real device is replicated based on a plurality of output histories of the target real device. For example, the V camera 530 causes the response time or the recognition result to vary based on a plurality of output histories of the camera 53. For example, the V vision sensor 520 causes the recognition result or the response time of the V work 600 to vary, based on a plurality of output histories of the vision sensor 52. For example, the V robot hand 510 causes the response time to vary based on a plurality of output histories of the robot hand 51.

When the V vision sensor 520 outputs a recognition result of the V work 600 based on a plurality of output histories of the vision sensor 52, the simulation execution unit 112 may reflect the recognition result to the V work 600. For example, the simulation execution unit 112 may change the arrangement of the V work 600 so as to be the arrangement indicating by the recognition result output by the V vision sensor 520. In this manner, the output to the VRC 300 by the V vision sensor 520 can be varied according to the variation in the output from the vision sensor 52 to the RC 30, and the arrangement of the target V work 600 can also be changed according to the variation, enabling the variation to be reflected even in a scene where the V work 600 is subsequently handled, which can contribute to the improvement in the accuracy of the simulation.

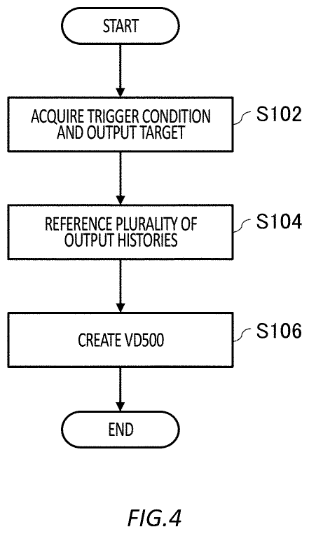

FIG. 4 schematically illustrates an example of a processing flow at the simulation system 10. Herein, an example of a processing flow is described in which the simulator 100 creates the VD 500 that simulates a target device.

At step (steps may be described in abbreviation as S) 102, the acquisition unit 104 acquires a trigger condition and an output target to be output when the trigger condition is satisfied. For example, the acquisition unit 104 acquires, as the trigger condition, that an instruction from the VRC 300 has been received, and acquires, as the output target, a response to be output by executing an operation according to the instruction.

At S104, the history referencing unit 108 references a plurality of output histories of the target device. At S106, the creation unit 106 creates a VD 500 that outputs the output target to be output when the trigger condition acquired by the acquisition unit 104 at S102 is satisfied. The creation unit 106 creates a VD 500 that performs an output based on the plurality of output histories referenced by the history referencing unit 108 at S104. The creation unit 106 creates a list including an output for each output of the VD 500 by using the plurality of output histories, for example, and sets the VD 500 to perform an output according to said list.

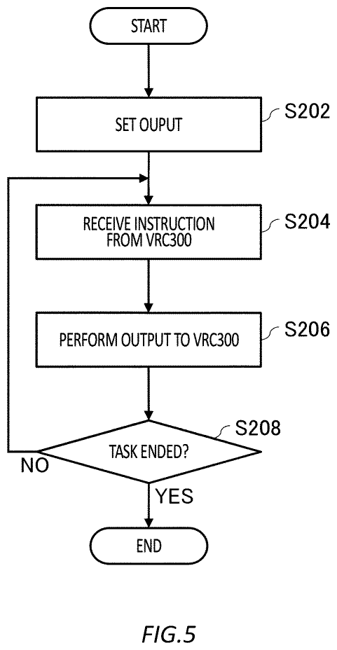

FIG. 5 schematically illustrates an example of a processing flow at the simulation system 10. Herein, an example of a processing flow is described in which the VD 500 executes a task of executing an operation for a predetermined number of times where it accepts an output setting based on the plurality of output histories, and executes an operation according to the instruction from the VRC 300 to perform an output to the VRC 300.

At S202, the VD 500 accepts an output setting by the creation unit 106. The creation unit 106 sets the output of the VD 500 such that the output of the VD 500 is varied for each output. Herein, the creation unit 106 sets the VD 500 to perform an output using a list including a plurality of time series output histories of the target device.

At S204, the VD 500 receives an instruction from the VRC 300. At S206, the VD 500 performs an output to the VRC 300 according to the output setting accepted at S202. The VD 500 performs an output using the first output history on the list.

When the task is ended (YES at S208), the processing is ended, and when the task is not ended (NO at S208), the processing returns to S204. At S204, the VD 500 receives an instruction from the VRC 300. At S206, the VD 500 performs an output using the second output history on the list. In this manner, the VD 500 selects, for each output, an output history in order from the first one on the list to be used. In this manner, the output of the VD 500 is varied for each output. Note that, although in FIG. 5, a case where an operation according to an instruction from the VRC 300 is executed by the VD 500 to perform an output to the VRC 300 is described, the same may be applied to a case where an operation according to an instruction from the VCC 200 is executed by the VD 500 to perform an output to the VCC 200.

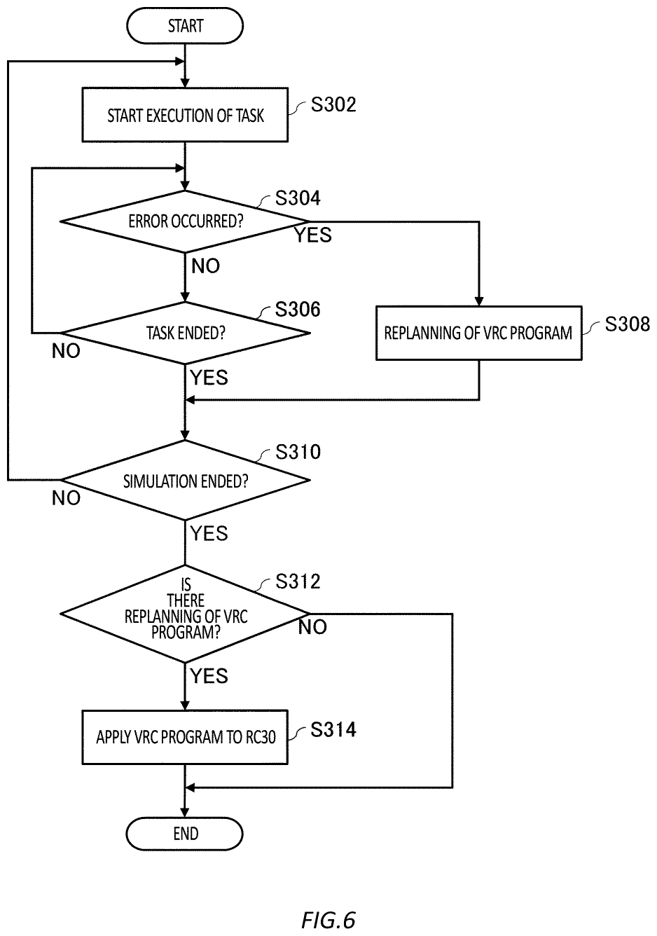

FIG. 6 schematically illustrates an example of a processing flow at the simulation system 10. Herein, an example of a processing flow is schematically illustrated where the replanning unit 120 performs replanning of a program on which the VRC 300 is based when being operated, while causing the simulation execution unit 112 to execute a simulation in which the same task is repeatedly executed in the virtual environment 101.

At S302, the simulation execution unit 112 starts execution of the task. In the simulation, the VRC 300 is operated according to to a program, the VR 400 is operated according to an instruction from the VRC 300, and the VD 500 performs an output, in response to the instruction from the VRC 300, based on a plurality of output histories of the real device. The output of the VD 500 is varied for each output.

When the task is ended (YES at S306) without any error occurring during the progress of the task (NO at S304), the processing is advanced to S310. When an error occurs during the progress of the task (YES at S304), the processing is advanced to S308).

At S308, the replanning unit 120 performs replanning of the program of the VRC 300. The replanning unit 120 performs replanning of the program of the VRC 300 such that the error that occurred is avoided.

At S310, the replanning unit 120 determines whether or not the simulation is to be ended. When it is determined not to be ended, the processing returns to S302, and when it is determined to be ended, the processing is advanced to S312. When the task was able to be executed for a predetermined number of times without any error occurring, the replanning unit 120 determines that the simulation is to be ended. For example, the replanning unit 120 counts up the number of times when the task is ended without any error occurring, and resets the number of times when an error occurs.

Between the start to the end of the simulation, when replanning of the program of the VRC 300 had been executed (YES at S312), the processing is advanced to S314, and when it had not been executed, the processing is ended. At S314, the application unit 118 applies the finally replanned program of the VRC 300 to the RC 30. Note that, although in FIG. 6, a case is described where the replanning unit 120 performs replanning of a program on which the VRC 300 is based when being operated, the replanning unit 120 may similarly perform replanning of a program on which the VCC 200 is based when being operated. That is, in the simulation at S302, the VCC 200 is operated according to a program and the VD 500 performs an output, in response to the instruction from the VCC 200, based on a plurality of output histories of the real device, the replanning unit 120 performs replanning of a program of the VCC 200 at S308, and the application unit 118 applies the finally replanned program of the VCC 200 to the CC 20 at S314. The replanning unit 120 may execute replanning of the program of the VCC 200 together with replanning of the program of the VRC 300.

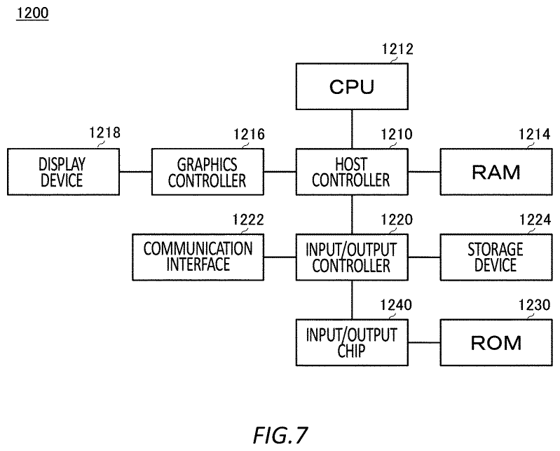

FIG. 7 schematically illustrates an example of a hardware configuration of a computer 1200 that functions as the simulation system 10 or the simulator 100. A program installed in the computer 1200 may cause the computer 1200 to function as the virtual environment 101. A program installed in the computer 1200 may cause the computer 1200 to function as the simulator 100. Such a program may be executed by a CPU 1212 to cause the computer 1200 to perform particular operations associated with some or all of the blocks in the flowcharts and block diagrams described in the present specification. Each of the VCC 200, the VRC 300, the VR 400, and the VD 500 may be achieved by one or more CPUs 1212.

The computer 1200 includes the CPU 1212, the RAM 1214, and the graphics controller 1216, and these are connected to one another by the host controller 1210. The computer 1200 also includes input/output units such as a communication interface 1222, a storage device 1224, a DVD drive and an IC card drive, which are connected to the host controller 1210 via an input/output controller 1220. The storage device 1224 may be a hard disk drive, a solid-state drive, and the like. The computer 1200 also includes a ROM 1230 and a legacy input/output unit such as a keyboard, which are connected to the input/output controller 1220 via an input/output chip 1240. The CPU 1212 operates according to the programs stored in the ROM 1230 and the RAM 1214, thereby controlling each unit. The graphics controller 1216 acquires image data generated by the CPU 1212, and causes the image data to be displayed on a display device 1218. The communication interface 1222 communicates with another electronic device via a network. The storage device 1224 stores the program and data used by the CPU 1212. Information processing written in the program is read by the computer 1200, and provides cooperation between the program and the above-described various types of hardware resources.

Blocks in flowcharts and block diagrams in the present embodiments may represent steps of processes in which operations are executed or “units” of apparatuses responsible for executing operations. A specific step and “unit” may be implemented by a dedicated circuit, a programmable circuit supplied along with a computer-readable instruction stored on a computer-readable storage medium, and/or a processor supplied along with the computer-readable instruction stored on the computer-readable storage medium. The dedicated circuit may include a digital and/or analog hardware circuit, or may include an integrated circuit (IC) and/or a discrete circuit. The programmable circuit may include, for example, a reconfigurable hardware circuit including logical AND, logical OR, logical XOR, logical NAND, logical NOR, and another logical operation, and a flip-flop, a register, and a memory element, such as a field programmable gate array (FPGA), a programmable logic array (PLA), or the like.

The computer-readable storage medium may include any tangible device capable of storing an instruction executed by an appropriate device, so that the computer-readable storage medium having the instruction stored thereon constitutes a product including an instruction that may be executed in order to provide means for executing an operation designated by a flowchart or a block diagram. An example of the computer-readable storage medium may include an electronic storage medium, a magnetic storage medium, an optical storage medium, an electromagnetic storage medium, a semiconductor storage medium, etc. The computer-readable instruction may be provided in a processor of a general computer, a special-purpose computer, or another programmable data processing apparatus, or in a programmable circuit locally, or via a local area network (LAN), a wide area network (WAN) such as the Internet in order to execute said computer-readable instruction for generating means for the processor of a programmable data processing apparatus such as a computer or a programmable circuit to execute an operation designated in the flowchart or the block diagram. An example of the processor includes a computer processor, a central processing unit, a processing unit, a microprocessor, a digital signal processor, a controller, a microcontroller, or the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multiprocessor-aware programming.

While the embodiments of the present invention have been described, the technical scope of the present invention is not limited to the above-described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process executed by a device, system, program, and method shown in the claims, embodiments, or diagrams can be achieved in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be executed in this order.

### EXPLANATION OF REFERENCES

10: simulation system; 20: CC; 22: cell, 30: RC; 40: robot; 51: robot hand; 52: vision sensor; 53: camera; 60: work; 72, 74, 76: rack; 80: DB; 100: simulator; 101: virtual environment; 102: storage unit; 104: acquisition unit; 106: creation unit; 108: history referencing unit; 110: response time computing unit; 112: simulation execution unit; 114: image creating unit; 116: communication adjustment unit; 118: application unit; 120: replanning unit; 122: presentation unit; 124: change accepting unit; 200: VCC; 300: VRC; 400: VR; 500: VD; 510: V robot hand; 520: V vision sensor; 530: V camera; 600: V work; 720, 740, 760: V rack; 800: VDB; 1200: computer; 1210: host controller; 1212: CPU; 1214: RAM; 1216: graphics controller; 1218: display device; 1220: input/output controller; 1222: communication interface; 1224: storage device; 1230: ROM; 1240: input/output chip.

What is claimed is:

1. A simulation system that simulates an operation of a cell including a robot and a device, the simulation system comprising:
one or more processors,
wherein the one or more processors achieve:
a virtual device that simulates an output of the device; and
a virtual robot controller that simulates, according to an output of the virtual device, an operation of a robot controller that controls the robot, and
the virtual device performs an output based on a plurality of output histories of the device.

2. The simulation system according to claim 1, wherein the virtual device performs the output that is different for each output, based on the plurality of output histories.

3. The simulation system according to claim 1, wherein the one or more processors perform, based on the output of the virtual device and a result of simulation performed by the virtual robot controller according to the output, replanning of a program on which an operation of the robot controller is based.

4. The simulation system according to claim 3, wherein the one or more processors execute, based on the program having been modified, a simulation by the virtual robot controller multiple times according to the output of the virtual device to confirm that no error occurs.

5. The simulation system according to claim 3, wherein the one or more processors change, based on an output of the virtual device and a result of simulation by the virtual robot controller based on the program according to the output, at least any of a selection of a command to instruct an operation of a robot, an order of commands, adjustment of command arguments, a logic to invoke a command, or timing at which a command is to be invoked, in the program.

6. The simulation system according to claim 2, wherein the virtual device performs the output such that response time differs for each output, based on the plurality of output histories.

7. The simulation system according to claim 6, wherein
an output history of the device includes instruction history data indicating an instruction to the device and a response from the device at each time,
the one or more processors computes, from a plurality of pieces of the instruction history data, a plurality of response times from when an instruction is input to the device to when a response is output of by the device,
wherein the virtual device performs the output such that a response time differs for each output, based on the plurality of response times.

8. The simulation system according to claim 6, wherein the virtual device that simulates an output of a robot hand performs the output such that a response time differs for each output, based on a plurality of opening and closing operation histories of the robot hand.

9. The simulation system according to claim 1, wherein
an output history of the device includes output data output by the device to the robot controller, and
the virtual device outputs different output data for each output, based on the plurality of output histories.

10. A simulation system according to claim 9, wherein the virtual device that simulates a n output of a vision sensor for recognizing a work outputs a different recognition result for each output, based on a plurality of recognition results of the vision sensor.

11. The simulation system according to claim 10, wherein
the one or more processors create a different image for each output, based on the plurality of recognition results of the vision sensor, wherein
the virtual device outputs a recognition result of the work in the image.

12. The simulation system according to claim 1, wherein the virtual device selects and outputs one output history, among the plurality of output histories, that is different for each output.

13. The simulation system according to claim 12, wherein the virtual device selects and outputs the output history in a time series order from the plurality of output histories in time series.

14. The simulation system according to claim 12, wherein two or more of the virtual devices, each being identical to the virtual device, respectively select and output, from the plurality of output histories of the device corresponding to each of the virtual devices, one output history at corresponding timing with each other.

15. The simulation system according to claim 12, wherein
the virtual robot controller performs simulation based on an operation history of the robot controller, and
the virtual device selects and outputs, from the plurality of output histories, one output history corresponding to timing of an operation history on which the virtual robot controller is based.

16. The simulation system according to claim 1, wherein
the one or more processors acquire a trigger condition and an output target when the trigger condition is satisfied; and
the one or more processors create, based on the trigger condition and the output target acquired, the virtual device that outputs the output target when the trigger condition is satisfied.

17. The simulation system according to claim 1, wherein
the one or more processors adjust a communication delay between the virtual device and the virtual robot controller based on a plurality of communication delay histories between the device and the robot controller.

18. A simulation method for simulating an operation of a cell including a robot and a device, the method comprising:
performing, by a virtual device that simulates an output of the device, an output based on a plurality of output histories of the device; and
simulating, according to an output of the virtual device, an operation of a robot controller that controls the robot.

19. A simulation system for simulating an operation of a cell including a robot and a device, the simulation system comprising:
one or more processors,
wherein the one or more processors achieve a virtual device that simulates an output of the device, the simulation system includes a robot controller that controls the robot according to an output of the virtual device, and
the virtual device performs an output based on a plurality of output histories of the device.
